(19) United States
(12) Patent Application Publication
(10) Pub. No.: US 2024/0204352 A1
(43) Pub. Date: Jun. 20, 2024

(54) JOINING METHOD

(71) Applicant: HONDA MOTOR CO., LTD., TOKYO (JP)

(72) Inventor: Suguru OMORI, WAKO-SHI (JP)

(21) Appl. No.: 18/533,305

(22) Filed: Dec. 8, 2023

(30) Foreign Application Priority Data
Dec. 14, 2022 (JP) 2022-199379

(51) Int. Cl. H01M 50/403; H01M 50/46

(52) U.S. Cl. CPC H01M 50/403; H01M 50/46; H01M 8/10

(57) ABSTRACT

A joining method of joining two separators includes bringing a first separator and a second separator into contact with each other, bringing a first welding electrode into contact with a first inward ridge, bringing a second welding electrode into contact with the second inward ridge, and welding a plurality of portions where a first outward ridge and a second outward ridge are contact with each other by causing a current to flow between the first welding electrode and the second welding electrode.

### CROSS-REFERENCE TO RELATED APPLICATIONS

This application is based upon and claims the benefit of priority from Japanese Patent Application No. 2022-199379 filed on Dec. 14, 2022, the contents of which are incorporated herein by reference.

### BACKGROUND OF THE INVENTION

### Field of the Invention

The present invention relates to a method for joining two adjacent separators in a fuel cell stack.

### Description of the Related Art

The fuel cell stack includes a plurality of stacked unit cells. Each of the unit cells includes a membrane electrode assembly (MEA) and a pair of separators (a first separator and a second separator) sandwiching the MEA. The MEA includes a solid polymer electrolyte membrane, an anode, and a cathode. The solid polymer electrolyte membrane is formed of a polymer ion exchange membrane. The anode is disposed on one surface of the solid polymer electrolyte membrane. The cathode electrode is disposed on another surface of the solid polymer electrolyte membrane.

A plurality of ridges extending in the longitudinal direction of the separator are formed on both surfaces of each separator. Thus, a flow field (fuel gas flow field) for allowing the fuel gas to flow and a bead seal for sealing the flow field are formed between the MEA and the first separator. Further, a flow field (oxygen-containing gas flow field) for allowing the oxygen-containing gas to flow and a bead seal for sealing the flow field are formed between the MEA and the second separator. In addition, in two unit cells adjacent to each other, a flow field (coolant flow field) for allowing a coolant to flow is formed between a first separator of one unit cell and a second separator of the other unit cell.

JP 2007-311069 A discloses a fuel cell stack in which a plurality of unit cells are stacked. In this fuel cell stack, the first separator of the first unit cell and the second separator of the second unit cell are joined together. Specifically, the convex portions of the first separator and the convex portions of the second separator are welded. Thus, a temperature control medium flow field (coolant flow field) is formed.

### SUMMARY OF THE INVENTION

In general, spot welding is used for welding the convex portion of the first separator and the convex portion of the second separator. That is, the contact portion between the convex portion of the first separator and the convex portion of the second separator is sandwiched between the pair of electrodes, and the contact portion is welded. Depending on the shape of the convex portion of the first separator and the convex portion of the second separator, it may not be possible to dispose the contact portion between the pair of electrodes. Therefore, welding cannot be performed appropriately.

An object of the present invention is to solve the aforementioned problem.

A joining method according to an aspect of the present invention is provided for joining two adjacent separators in a fuel cell stack in which unit cells are stacked, each of the unit cells including a membrane electrode assembly and a pair of separators sandwiching the membrane electrode assembly, wherein the two adjacent separators are a first separator covering a cathode of a first membrane electrode assembly and a second separator covering an anode of a second membrane electrode assembly, the first separator includes a plurality of first inward ridges that are in contact with the cathode of the first membrane electrode assembly and a plurality of first outward ridges that protrude toward the second separator, and the second separator includes a plurality of second inward ridges that are in contact with the anode of the second membrane electrode assembly and a plurality of second outward ridges that protrude toward the first separator. The joining method includes bringing the first separator and the second separator into contact with each other, bringing a first welding electrode into contact with the plurality of first inward ridges, bringing a second welding electrode into contact with the plurality of second inward ridges, and welding a plurality of portions where the first outward ridges and the second outward ridges are in contact with each other by causing a current to flow between the first welding electrode and the second welding electrode.

According to the present invention, welding can be performed in a portion where two adjacent separators are in contact with each other.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is an explanatory perspective view of a fuel cell stack;

FIG. 2 is an exploded perspective view of the fuel cell stack;

FIG. 3 is a cross-sectional view taken along line III-III of FIG. 2;

FIG. 4 is an explanatory exploded perspective view showing a unit cell of the fuel cell stack;

FIG. 5 is a plan view of a first separator as viewed from the MEA;

FIG. 6 is a plan view of a second separator as viewed from the MEA;

FIG. 7 is a plan view of the first separator as viewed from the second separator facing the first separator;

FIG. 8 is a plan view of the second separator as viewed from the first separator facing the second separator;

FIG. 9 is a manufacturing flow of a joint separator;

FIG. 10 is an explanatory diagram of a welding process according to a first embodiment;

FIG. 11 is an explanatory diagram of a welding process according to a second embodiment; and

FIG. 12 is an explanatory diagram of a welding area in the second embodiment.

### DETAILED DESCRIPTION OF THE INVENTION

### 1 Configuration of Fuel Cell Stack 10

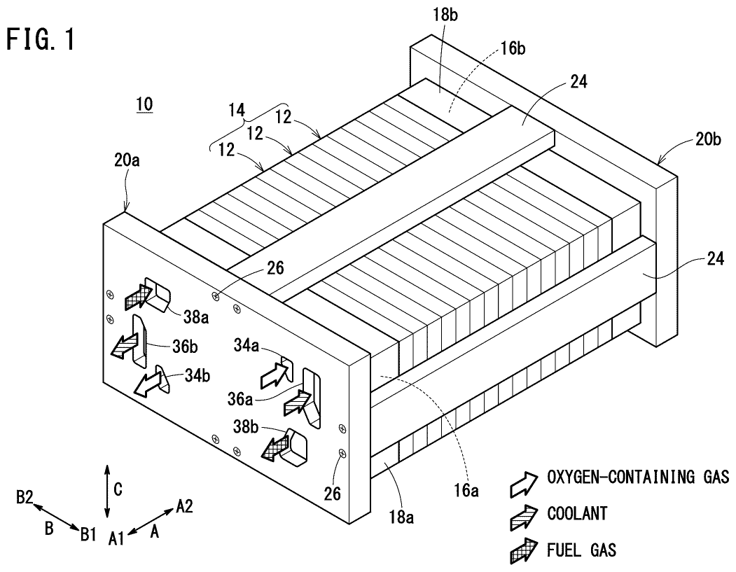

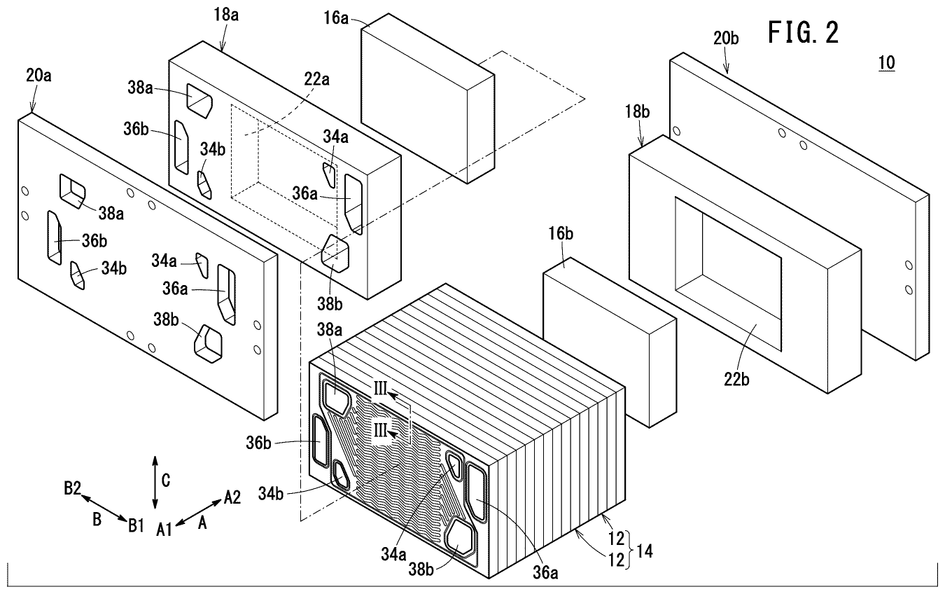

As shown in FIGS. 1 and 2, a fuel cell stack 10 includes a stack body 14 in which a plurality of unit cells 12 are stacked in a first direction (the direction of arrow A). The fuel cell stack 10 is used as, for example, power generation equipment of a fuel cell vehicle or each facility.

### 1-1 Configuration of Periphery of Stack Body 14

At a first end portion of the fuel cell stack 10 in the direction of arrow A1, a terminal plate 16a, an insulator 18a, and an end plate 20a are arranged in this order toward the outside (in the direction of arrow A1) (see FIG. 2). At a second end portion of the fuel cell stack 10 in the direction of arrow A2, a terminal plate 16b, an insulator 18b, and an end plate 20b are arranged in this order toward the outside (in the direction of arrow A2).

The terminal plates 16a and 16b are made of a conductive material. The insulators 18a and 18b are made of an insulating material. As shown in FIG. 2, a concave portion 22a that opens toward the stack body 14 is formed in the central portion of the insulator 18a. Similarly, a concave portion 22b that opens toward the stack body 14 is formed in the central portion of the insulator 18b. The terminal plate 16a is accommodated in the concave portion 22a. The terminal plate 16b is accommodated in the concave portion 22b. The stack body 14 is positioned between the insulator 18a and the insulator 18b.

As shown in FIG. 1, each of the end plates 20a, 20b are formed in a rectangular shape having long sides extending in the second direction (the direction of arrow B) and short sides extending in the third direction (the direction of arrow C). The first direction, the second direction, and the third direction are perpendicular to each other. Coupling bars 24 are disposed between the respective sides of the end plates 20a and 20b. One end of each of the coupling bars 24 is fixed to an inner surface of the end plate 20a using bolts 26. Another end of each of the coupling bars 24 is fixed to an inner surface of the end plate 20b using bolts 26. Thus, a fastening load in the stacking direction (the direction of arrow A) is applied to the stack body 14.

At first end portions of the insulator 18a and the end plate 20a in the direction of arrow B1, an oxygen-containing gas supply passage 34a, a coolant supply passage 36a, and a fuel gas discharge passage 38b are provided. At second end portions of the insulator 18a and the end plate 20a in the direction of arrow B2, a fuel gas supply passage 38a, a coolant discharge passage 36b, and an oxygen-containing gas discharge passage 34b are provided.

### 1-2 Configurations of Stack Body 14 and Unit Cell 12

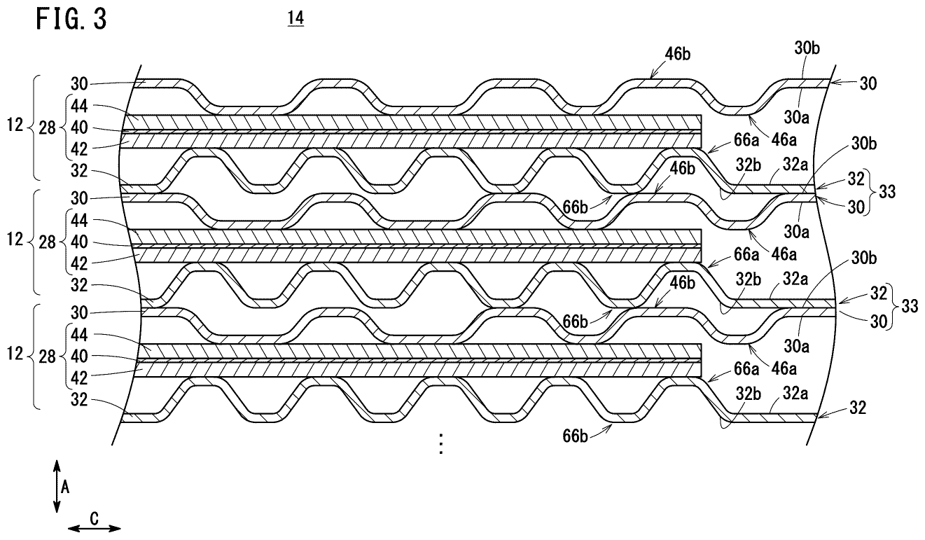

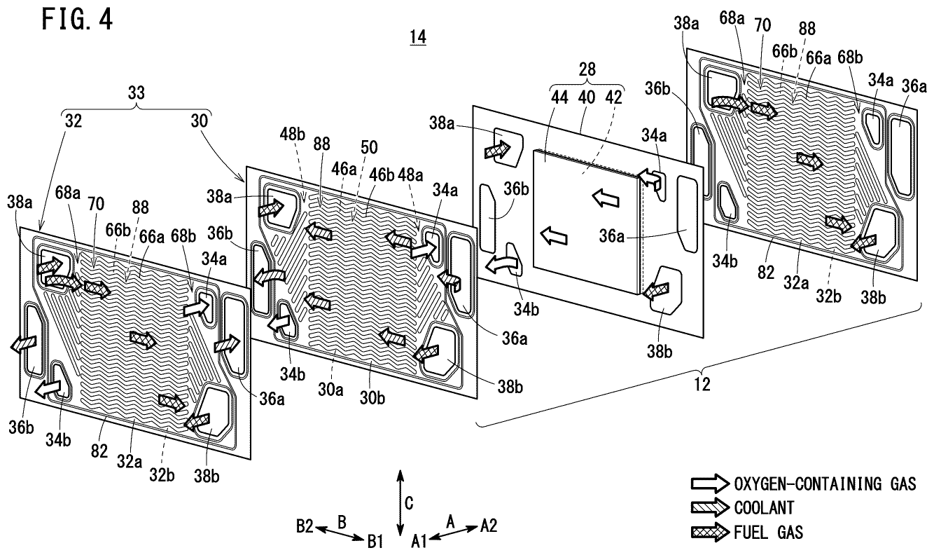

As shown in FIGS. 3 and 4, each of the unit cells 12 constituting the stack body 14 includes a membrane electrode assembly 28 (hereinafter also referred to as a “MEA 28”) and a pair of separators (first and second separators 30 and 32). The first separator 30 and the second separator 32 sandwich the MEA 28 therebetween. The first separator 30 and the second separator 32 are formed of, for example, a metal sheet such as a steel sheet, a stainless steel sheet, an aluminum sheet, or a plated steel sheet. The surface of the metal sheet may be subjected to a surface treatment for protection against corrosion.

In two unit cells 12 adjacent to each other, the first separator 30 of one unit cell 12 and the second separator 32 of another unit cell 12 are joined to each other. A joint body including the first separator 30 and the second separator 32 is referred to as a joint separator 33. That is, the stack body 14 is also a structure in which each of the MEAs 28 is sandwiched between two joint separators 33.

As shown in FIG. 2, at the first end portion of the unit cell 12 in the direction of arrow B1, the oxygen-containing gas supply passage 34a, the coolant supply passage 36a, and the fuel gas discharge passage 38b are provided. The oxygen-containing gas supply passages 34a of the respective unit cells 12 are arranged in the direction of arrow A, and communicate with each other. The oxygen-containing gas supply passage 34a of the stack body 14 communicates with the oxygen-containing gas supply passages 34a of the insulator 18a and the end plate 20a. The coolant supply passages 36a of the respective unit cells 12 are arranged in the direction of arrow A and communicate with each other. The coolant supply passage 36a of the stack body 14 communicates with the coolant supply passages 36a of the insulator 18a and the end plate 20a. The fuel gas discharge passages 38b of the respective unit cells 12 are arranged in the direction of arrow A and communicate with each other. The fuel gas discharge passage 38b of the stack body 14 communicates with the fuel gas discharge passages 38b of the insulator 18a and the end plate 20a.

As shown in FIG. 2, at the second end portion of the unit cell 12 in the direction of arrow B2, the fuel gas supply passage 38a, the coolant discharge passage 36b, and the oxygen-containing gas discharge passage 34b are provided. The fuel gas supply passages 38a of the respective unit cells 12 are arranged in the direction of arrow A and communicate with each other. The fuel gas supply passage 38a of the stack body 14 communicates with the fuel gas supply passages 38a of the insulator 18a and the end plate 20a. The coolant discharge passages 36b of the respective unit cells 12 are arranged in the direction of arrow A and communicate with each other. The coolant discharge passage 36b of the stack body 14 communicates with the coolant discharge passage 36b of the insulator 18a and the end plate 20a. The oxygen-containing gas discharge passages 34b of the respective unit cells 12 are arranged in the direction of arrow A, and communicate with each other. The oxygen-containing gas discharge passage 34b of the stack body 14 communicates with the oxygen-containing gas discharge passages 34b of the insulator 18a and the end plate 20a.

### 1-2-1 Configuration of Membrane Electrode Assembly 28 (MEA 28)

As shown in FIG. 3, each of the MEAs 28 has an electrolyte membrane 40, an anode 42, and a cathode 44. A resin film (not shown) is provided on the outer periphery of the electrolyte membrane 40. The anode 42 and the cathode 44 sandwich the solid polymer electrolyte membrane 40.

The electrolyte membrane 40, for example, is a solid polymer electrolyte membrane (cation ion exchange membrane). The solid polymer electrolyte membrane is formed by impregnating a thin membrane of perfluorosulfonic acid with water, for example. A fluorine based electrolyte may be used as the electrolyte membrane 40. Alternatively, an HC (hydrocarbon) based electrolyte may be used as the electrolyte membrane 40.

The anode 42 and the cathode 44 each include a gas diffusion layer (not shown) and an electrode catalyst layer (not shown). The gas diffusion layer is formed of carbon paper or the like. The electrode catalyst layer is formed by depositing porous carbon particles uniformly on the surface of the gas diffusion layer, and platinum alloy is supported on surfaces of the carbon particles. The electrode catalyst layers are formed on both surfaces of the solid polymer electrolyte membrane 40.

### 1-2-2 Configuration of Front Surface 30a of First Separator 30

As shown in FIG. 4, the first separator 30 covers the cathode 44 on the MEA 28. The first separator 30 has a front surface 30a facing the MEA 28 and a back surface 30b facing the second separator 32. A plurality of ridges or protrusions are formed on each of the front surface 30a and the back surface 30b by press forming. On the front surface 30a, each of the ridges protruding toward the MEA 28 is referred to as an inward ridge 46a. On the back surface 30b, each of the ridges protruding toward the second separator 32 is referred to as an outward ridge 46b.

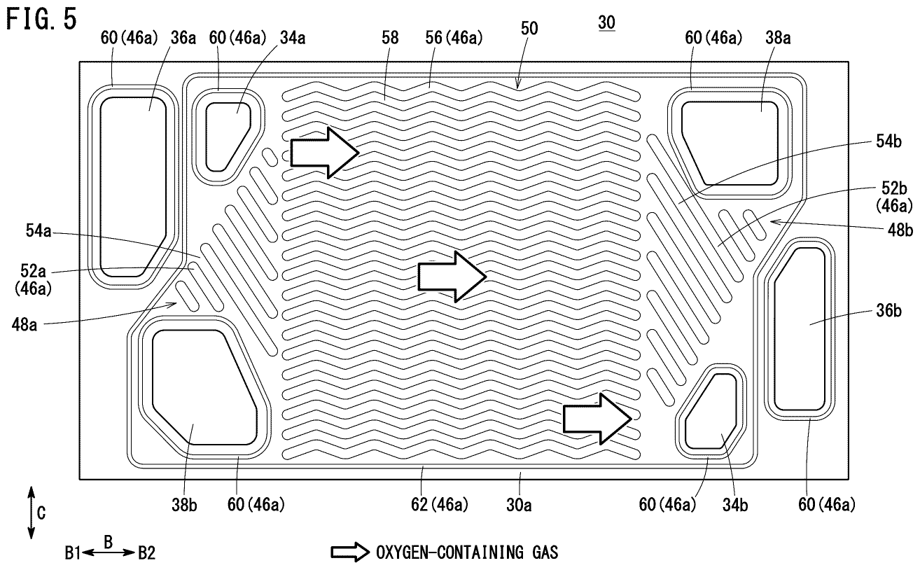

As shown in FIGS. 4 and 5, two oxygen-containing gas feed regions 48a and 48b, and an oxygen-containing gas flow field 50 are formed on the front surface 30a of the first separator 30 by the plurality of inward ridges 46a. The oxygen-containing gas feed region 48a allows the oxygen-containing gas from the oxygen-containing gas supply passage 34a to flow into the oxygen-containing gas flow field 50. The oxygen-containing gas feed region 48b allows the oxygen-containing gas from the oxygen-containing gas flow field 50 to flow into the oxygen-containing gas discharge passage 34b. The oxygen-containing gas flow field 50 is located between the oxygen-containing gas feed region 48a and the oxygen-containing gas feed region 48b, and faces the cathode 44. The two oxygen-containing gas feed regions 48a, 48b and the oxygen-containing gas flow field 50 connect and communicate with the oxygen-containing gas supply passage 34a and the oxygen-containing gas discharge passage 34b.

Among the plurality of inward ridges 46a, the inward ridges 46a forming the oxygen-containing gas feed region 48a are referred to as feed ridges 52a. Each of the feed ridges 52a extends linearly from the oxygen-containing gas supply passage 34a to the first end portion (an end portion in the direction of arrow B1) of the oxygen-containing gas flow field 50. Feed grooves 54a are located adjacent to the feed ridges 52a.

Among the plurality of inward ridges 46a, the inward ridges 46a forming the oxygen-containing gas feed region 48b are referred to as feed ridges 52b. Each of the feed ridges 52b extends linearly from the oxygen-containing gas discharge passage 34b to the second end portion (an end portion in the direction of arrow B2) of the oxygen-containing gas flow field 50. A feed groove 54b is located between the two feed ridges 52b that are adjacent to each other.

Among the plurality of inward ridges 46a, the inward ridges 46a forming the oxygen-containing gas flow field 50 are referred to as flow field ridges 56. In plan view of the first separator 30, each of the flow field ridges 56 has a wavy shape extending in the direction of arrow B. A flow field groove 58 is located between the two flow field ridges 56 that are adjacent to each other. Each of the flow field grooves 58 has a wavy shape as well. Each of the flow field ridges 56 is in contact with the cathode 44 of the MEA 28 located in the direction of arrow A2. The plurality of flow field grooves 58 serve as pathways through which the oxygen-containing gas flows.

The respective fluid passages or holes (the oxygen-containing gas supply passage 34a, the coolant supply passage 36a, the fuel gas discharge passage 38b, the fuel gas supply passage 38a, the coolant discharge passage 36b, and the oxygen-containing gas discharge passage 34b) are surrounded by the inward ridges 46a. These inward ridges 46a are referred to as passage bead seals 60. Each of the passage bead seals 60 is in contact with the MEA 28 located in the direction of arrow A2. Thus, the plurality of passage bead seals 60 seal the plurality of fluid passages.

A plurality of flow paths (not shown) communicating with the oxygen-containing gas supply passage 34a and the oxygen-containing gas feed region 48a are formed in the passage bead seal 60 surrounding the oxygen-containing gas supply passage 34a. Similarly, a plurality of flow paths (not shown) communicating with the oxygen-containing gas discharge passage 34b and the oxygen-containing gas feed region 48b are formed in the passage bead seal 60 surrounding the oxygen-containing gas discharge passage 34b.

An area including the two oxygen-containing gas feed regions 48a, 48b, the oxygen-containing gas flow field 50, the oxygen-containing gas supply passage 34a, the fuel gas discharge passage 38b, the fuel gas supply passage 38a, and the oxygen-containing gas discharge passage 34b is surrounded by the inward ridge 46a. This inward ridge 46a is referred to as an outer bead seal 62. The outer bead seal 62 is in contact with the MEA 28 located in the direction of arrow A2. Thus, the outer bead seal 62 seals an area where the oxygen-containing gas flows between the front surface 30a and the MEA 28 (an area including the two oxygen-containing gas feed regions 48a, 48b, the oxygen-containing gas flow field 50, the oxygen-containing gas supply passage 34a, and the oxygen-containing gas discharge passage 34b).

### 1-2-3 Configuration of Front Surface 32a of Second Separator 32

As shown in FIG. 4, the second separator 32 covers the anode 42 on the MEA 28. The second separator 32 has a front surface 32a facing the MEA 28 and a back surface 32b facing the first separator 30. A plurality of ridges or protrusions are formed on each of the front surface 32a and the back surface 32b by press forming. On the front surface 32a, each of the ridges protruding toward the MEA 28 is referred to as an inward ridge 66a. On the back surface 32b, each of the ridges protruding toward the first separator 30 is referred to as an outward ridge 66b.

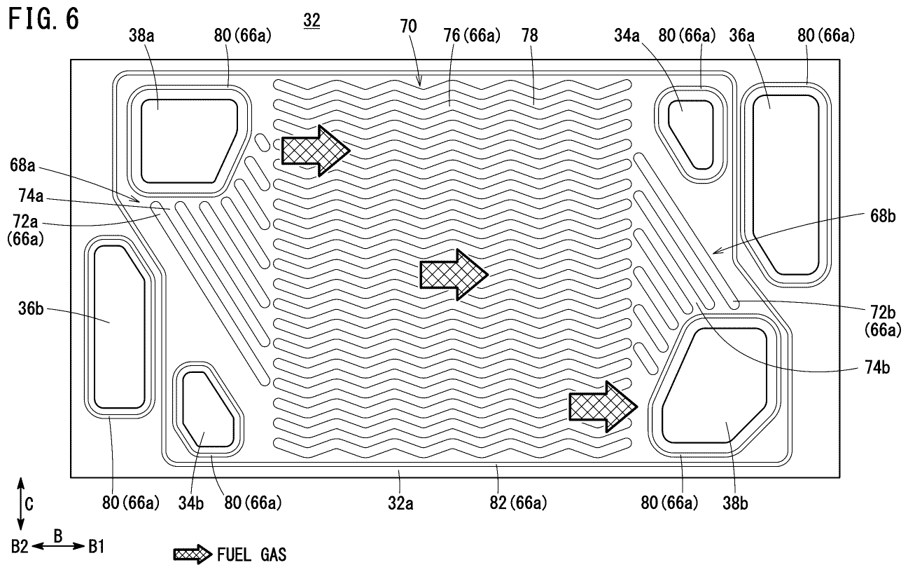

As shown in FIGS. 4 and 6, two fuel gas feed regions 68a and 68b, and a fuel gas flow field 70 are formed on the front surface 32a of the second separator 32 by the plurality of inward ridges 66a. The fuel gas feed region 68a allows the fuel gas from the fuel gas supply passage 38a to flow into the fuel gas flow field 70. The fuel gas feed region 68b allows the fuel gas from the fuel gas flow field 70 to flow into the fuel gas discharge passage 38b. The fuel gas flow field 70 is located between the fuel gas feed region 68a and the fuel gas feed region 68b, and faces the anode 42. The two fuel gas feed regions 68a, 68b and the fuel gas flow field 70 connect and communicate with the fuel gas supply passage 38a and the fuel gas discharge passage 38b.

Among the plurality of inward ridges 66a, the inward ridges 66a forming the fuel gas feed region 68a are referred to as feed ridges 72a. Each of the feed ridges 72a extends linearly from the fuel gas supply passage 38a to the first end portion (an end portion in the direction of arrow B2) of the fuel gas flow field 70. A feed groove 74a is located between the two feed ridges 72a that are adjacent to each other.

Among the plurality of inward ridges 66a, the inward ridges 66a forming the fuel gas feed region 68b are referred to as feed ridges 72b. Each of the feed ridges 72b extends linearly from the fuel gas discharge passage 38b to the second end portion (an end portion in the direction of arrow B1) of the fuel gas flow field 70. A feed groove 74b is located between the two feed ridges 72b that are adjacent to each other.

Among the plurality of inward ridges 66a, the inward ridges 66a forming the fuel gas flow field 70 are referred to as flow field ridges 76. In plan view of the second separator 32, each of the flow field ridges 76 has a wavy shape extending in the direction of arrow B. A flow field groove 78 is located between the two flow field ridges 76 that are adjacent to each other. Each of the flow field grooves 78 has a wavy shape as well. Each of the flow field ridges 76 is in contact with the anode 42 of the MEA 28 located in the direction of arrow A1. The plurality of flow field grooves 78 serve as pathways through which the fuel gas flows.

The waveform of the flow field ridges 76 and the flow field grooves 78 in the front surface 32a of the second separator 32 differs from the waveform of the flow field ridges 56 and the flow field grooves 58 in the front surface 30a of the first separator 30, in at least one of phase, period, or amplitude.

The respective fluid passages or holes (the fuel gas supply passage 38a, the coolant discharge passage 36b, the oxygen-containing gas discharge passage 34b, the oxygen-containing gas supply passage 34a, the coolant supply passage 36a, and the fuel gas discharge passage 38b) are surrounded by the inward ridges 66a. These inward ridges 66a are referred to as passage bead seals 80. Each of the passage bead seals 80 is in contact with the MEA 28 located in the direction of arrow A1. Thus, the plurality of passage bead seals 80 seal the plurality of fluid passages.

A plurality of flow paths (not shown) communicating with the fuel gas supply passage 38a and the fuel gas feed region 68a are formed in the passage bead seal 80 surrounding the fuel gas supply passage 38a. Similarly, a plurality of flow paths (not shown) communicating with the fuel gas discharge passage 38b and the fuel gas feed region 68b are formed in the passage bead seal 80 surrounding the fuel gas discharge passage 38b.

An area including the two fuel gas feed regions 68a and 68b, the fuel gas flow field 70, the fuel gas supply passage 38a, the oxygen-containing gas discharge passage 34b, the oxygen-containing gas supply passage 34a, and the fuel gas discharge passage 38b is surrounded by the inward ridge 66a. This inward ridge 66a is referred to as an outer bead seal 82. The outer bead seal 82 is in contact with the MEA 28 located in the direction of arrow A1. Thus, the outer bead seal 82 seals an area where the fuel gas flows between the front surface 32a and the MEA 28 (an area including the two fuel gas feed regions 68a, 68b, the fuel gas flow field 70, the fuel gas supply passage 38a, and the fuel gas discharge passage 38b).

### 1-2-4 Configuration of Back Surface 30b and Back Surface 32b

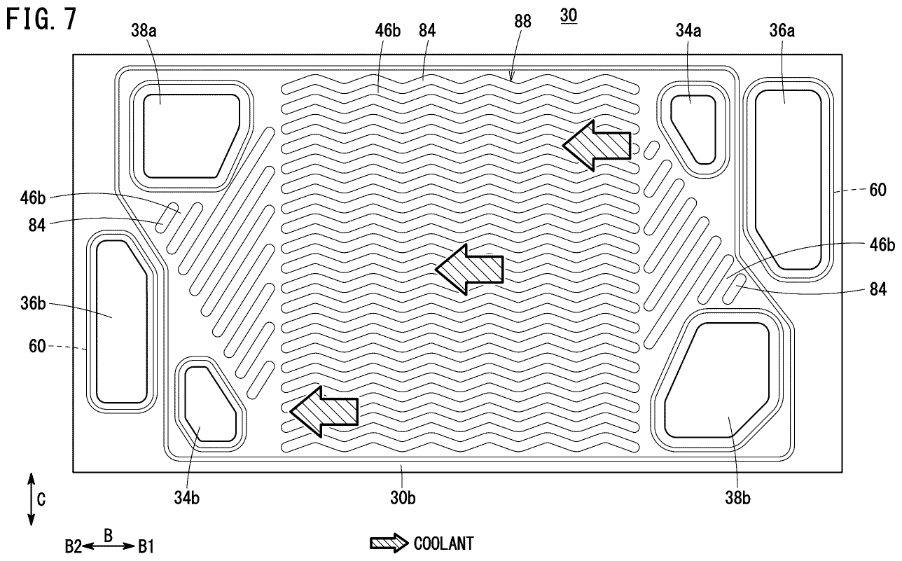

As shown in FIG. 7, in the back surface 30b of the first separator 30, the outward ridges 46b are located on the back side of the grooves (the feed grooves 54a and 54b, the flow field grooves 58, etc.) of the front surface 30a. Outward grooves 84 are located adjacent to the outward ridges 46b. The outward grooves 84 are located on the back side of the inward ridges 46a (the feed ridges 52a and 52b, the flow field ridges 56, etc.) of the front surface 30a.

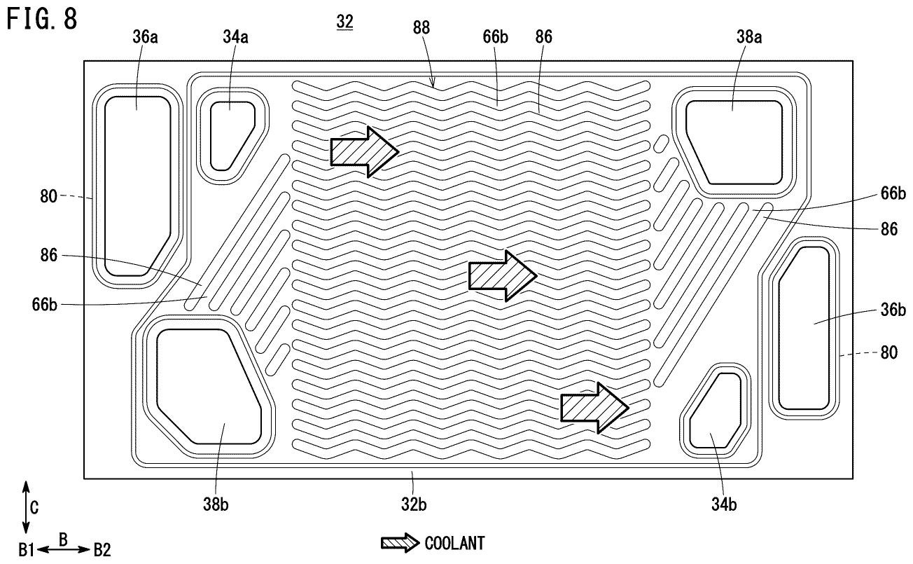

As shown in FIG. 8, in the back surface 32b of the second separator 32, the outward ridges 66b are located on the back side of the grooves (the feed grooves 74a and 74b, the flow field grooves 78, etc.) of the front surface 32a. Outward grooves 86 are located adjacent to the outward ridges 66b. The outward grooves 86 are located on the back side of the inward ridges 66a (the feed ridges 72a and 72b, the flow field ridges 76, etc.) of the front surface 32a.

The waveform of the outward ridges 46b located on the back side of flow field grooves 58 in the first separator 30 differs from the waveform of the outward ridges 66b located on the back side of flow field grooves 78 in the second separator 32, in at least one of phase, period, or amplitude.

As shown in FIG. 4, the back surface 30b of the first separator 30 and the back surface 32b of the second separator 32 face each other, and some of the outward ridges 46b and some of the outward ridges 66b are welded to each other. Further, the marginal portion of the first separator 30 and the marginal portion of the second separator 32 are welded. Also, parts of the first separator 30 and the second separator 32 located around each of the fluid passages are welded to each other. A coolant flow field 88 is formed between the back surface 30b of the first separator 30 and the back surface 32b of the second separator 32.

Some of the outward ridges 46b of the first separator 30 are in contact with some of the outward ridges 66b of the second separator 32. Some of the outward grooves 84 of the first separator 30 overlap some of the outward grooves 86 of the second separator 32.

A plurality of flow paths (not shown) communicating with the coolant supply passage 36a and the outward grooves 84 are formed in the passage bead seal 60 surrounding the coolant supply passage 36a of the first separator 30. Similarly, a plurality of flow paths (not shown) communicating with the coolant supply passage 36a and the outward grooves 86 are formed in the passage bead seal 80 surrounding the coolant supply passage 36a of the second separator 32.

A plurality of flow paths (not shown) communicating with the coolant discharge passage 36b and the outward grooves 84 are formed in the passage bead seal 60 surrounding the coolant discharge passage 36b of the first separator 30. Similarly, a plurality of flow paths (not shown) communicating with the coolant discharge passage 36b and the outward grooves 86 are formed in the passage bead seal 80 surrounding the coolant discharge passage 36b of the second separator 32.

### 2 Operation of Fuel Cell Stack 10

As shown in FIG. 1, an oxygen-containing gas is supplied to the oxygen-containing gas supply passage 34a of the end plate 20a. A fuel gas such as a hydrogen containing gas or the like is supplied to the fuel gas supply passage 38a of the end plate 20a. A coolant (such as pure water) is supplied to the coolant supply passage 36a in the end plate 20a. In each of the unit cells 12, each fluid flows as follows.

As shown in FIG. 4, the oxygen-containing gas supplied to the oxygen-containing gas supply passage 34a flows into the oxygen-containing gas feed region 48a. The oxygen-containing gas flowing into the oxygen-containing gas feed region 48a is uniformly distributed to the plurality of flow field grooves 58 of the oxygen-containing gas flow field 50. In the oxygen-containing gas flow field 50, the oxygen-containing gas is supplied to the cathode 44 of the MEA 28. On the other hand, the fuel gas supplied to the fuel gas supply passage 38a flows into the fuel gas feed region 68a. The fuel gas flowing into the fuel gas feed region 68a is uniformly distributed to the plurality of flow field grooves 78 of the fuel gas flow field 70. The fuel gas is supplied to the anode 42 of the MEA 28 in the fuel gas flow field 70. In each of the MEAs 28, the oxygen-containing gas supplied to the cathode 44 and the fuel gas supplied to the anode 42 induce chemical reactions, and thereby generate electricity. Water is generated as a result of the chemical reactions.

Then, the unreacted oxygen-containing gas and water flow into the oxygen-containing gas feed region 48b from the oxygen-containing gas flow field 50. Further, the oxygen-containing gas flowing into the oxygen-containing gas feed region 48b flows out to the oxygen-containing gas discharge passage 34b. On the other hand, the unreacted fuel gas flows into the fuel gas feed region 68b from the fuel gas flow field 70. Further, the fuel gas flowing into the fuel gas feed region 68b flows out to the fuel gas discharge passage 38b.

The coolant supplied to the coolant supply passage 36a flows into the coolant flow field 88. In the coolant flow field 88, the coolant cools the MEA 28 located in the direction of arrow A. The coolant in the coolant flow field 88 flows out to the coolant discharge passage 36b.

### 3 Joining Method of Joint Separator 33

In the joint separator 33, the contact portions between the first separator 30 and the second separator 32 are joined. In the joint separator 33, the marginal portion of the first separator 30 and the marginal portion of the second separator 32 are joined to each other.

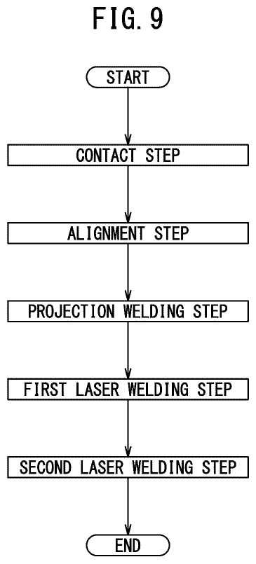

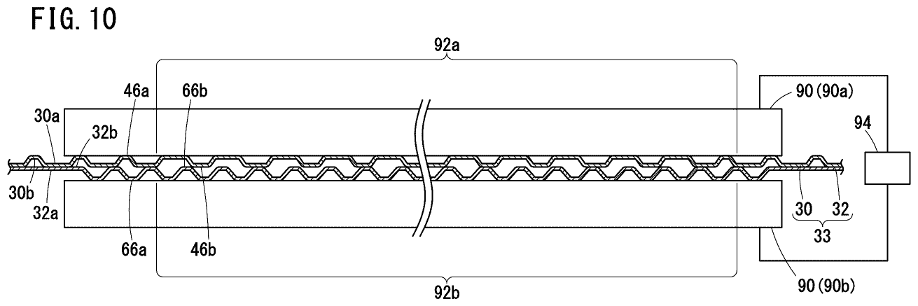

As shown in FIGS. 7 and 8, the outward ridges 46b of the first separator 30 and the outward ridges 66b of the second separators 32 are not symmetrical shapes. Therefore, some of the outward ridges 46b and some of the outward ridges 66b are in contact with each other in a state where the back surface 30b of the first separator 30 and the back surface 32b of the second separator 32 face each other. In addition, the contact area of each contact portion is small. Therefore, it is difficult to bring the electrodes for spot welding close to each of the contact portions. Therefore, in the present embodiment, the outward ridges 46b and the outward ridges 66b are joined by projection welding. As shown in FIGS. 9 and 10, a pair of projection welding electrodes 90 (a first electrode 90a and a second electrode 90b) are used in projection welding.

As shown in FIG. 9, the first separator 30 and the second separator 32 are joined in the order of a contact step, an alignment step, a projection welding step, a first laser welding step, and a second laser welding step.

### 3-1 First Embodiment

As shown in FIG. 10, the pair of projection welding electrodes 90 used in the first embodiment is larger than a power generation area 92a of the first separator 30 and a power generation area 92b of the second separator 32 in plan view. The pair of electrodes 90 are connected to an electric circuit 94 for supplying electric current for welding. The electric circuit 94 includes a transformer, a power supply, and the like (not shown).

The power generation area 92a of the first separator 30 includes the inward ridges 46a that are in contact with the cathode 44. The power generation area 92a is a portion of the first separator 30 that overlaps the cathode 44. The power generation area 92b of the second separator 32 includes the inward ridges 66a that are in contact with the anode 42. The power generation area 92a is a portion of the second separator 32 that overlaps the anode 42.

First, the first separator 30 and the second separator 32 are brought into contact with each other (contact step). The respective fluid passages (the oxygen-containing gas supply passage 34a and the like) of the first separator 30 and the respective fluid passages (the oxygen-containing gas supply passage 34a and the like) of the second separator 32 are aligned, and then the first separator 30 and the second separator 32 are superimposed. In this state, the plurality of outward ridges 46b of the first separator 30 and the plurality of outward ridges 66b of the second separator 32 are in contact with each other. There are also a plurality of outward ridges 46b and 66b which do not contact each other.

Next, the pair of electrodes 90 are aligned (alignment step). The first electrode 90a is disposed at a position facing the front surface 30a of the first separator 30. Also, the first electrode 90a is disposed at the position overlapping the entire power generation area 92a of the first separator 30 in plan view. Further, the first electrode 90a is brought close to the first separator 30 and brought into contact with the plurality of inward ridges 46a. Similarly, the second electrode 90b is disposed at a position facing the front surface 32a of the second separator 32. Also, the second electrode 90b is disposed at the position overlapping the entire power generation area 92b of the second separator 32 in plan view. Further, the second electrode 90b is brought close to the second separator 32 and brought into contact with the plurality of inward ridges 66a.

Next, projection welding is performed (projection welding step). Here, the electric circuit 94 causes a current to flow between the first electrode 90a and the second electrode 90b. In this way, in the outward ridges 46b located in the power generation area 92a and the outward ridges 66b of the second separator 32 located in the power generation area 92b, the several portions that are in contact with each other are welded simultaneously.

Next, first laser welding is performed (first laser welding step). Here, laser welding is performed between the outer peripheral portion of each of the fluid passages (the oxygen-containing gas supply passage 34a and the like) of the first separator 30 and the outer peripheral portion of each of the fluid passages (the oxygen-containing gas supply passage 34a and the like) of the second separator 32. That is, laser welding is performed between parts of the first separator 30 and the second separator 32 located around each of the fluid passages.

Finally, second laser welding is performed (second laser welding step). Here, laser welding is performed between the marginal portion of the first separator 30 and the marginal portion of the second separator 32. In the manner described above, the first separator 30 and the second separator 32 are joined together.

According to the first embodiment, by bringing the pair of electrodes 90 into contact with the plurality of inward ridges 46a and 66a, all the contact portions of the outward ridges 46b and 66b positioned between the pair of electrodes 90 can be welded. As described above, according to the first embodiment, it is not necessary to bring the pair of welding electrodes 90 into contact with the portions to be welded (the contact portions of the outward ridges 46b and 66b). Thus, the welding is easily performed. Further, according to the first embodiment, it is not necessary to weld the portions to be welded one by one. Therefore, the welding is easily performed. Further, according to the first embodiment, it is not necessary to accurately bring the welding electrode into contact with the portions to be welded, as in the spot welding. Therefore, the welding is easily performed. Further, according to the first embodiment, it is not necessary to accurately grasp the portions to be welded. Thus, the welding is easily performed. According to the first embodiment, all the portions to be welded can be welded by applying a current to the pair of electrodes 90. Thus, the welding operation is simple.

### 3-2 Second Embodiment

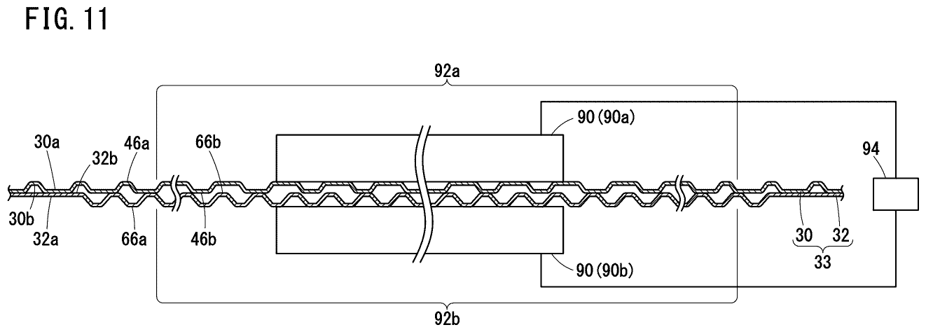

As shown in FIG. 11, a pair of projection welding electrodes 90 used in the second embodiment is smaller than the power generation area 92a of the first separator 30 and the power generation area 92b of the second separator 32 in plan view.

The pair of electrodes 90 used in the second embodiment is smaller than the pair of electrodes 90 used in the first embodiment. The current is supplied from the pair of electrodes 90 to the outward ridges 46b and 66b which are located away from the pair of electrodes 90, via the metal sheet portions which do not overlap with the pair of electrodes 90. However, the metal sheets serve as a resistance, and the current flowing through the outward ridges 46b and 66b away from the pair of electrodes 90 is reduced. Therefore, the outward ridges 46b and 66b away from the pair of electrodes 90 are not sufficiently joined. Therefore, in the second embodiment, it is necessary to perform projection welding by moving the pair of electrodes 90 to a plurality of welding positions. That is, in the second embodiment, the alignment step and the projection welding step need to be performed a plurality of times.

In the alignment step, the first electrode 90a is disposed at a position facing the front surface 30a of the first separator 30. Also, the first electrode 90a is disposed at the position overlapping part of the power generation area 92a of the first separator 30 in plan view. Further, the first electrode 90a is brought close to the first separator 30 and brought into contact with the plurality of inward ridges 46a. Similarly, the second electrode 90b is disposed at a position facing the front surface 32a of the second separator 32. Also, the second electrode 90b is disposed at the position overlapping part of the power generation area 92b of the second separator 32 in plan view. Further, the second electrode 90b is brought close to the second separator 32 and brought into contact with the plurality of inward ridges 66a.

In the projection welding step, the electric circuit 94 causes a current to flow between the first electrode 90a and the second electrode 90b. In this way, in the outward ridges 46b and the outward ridges 66b located between the pair of electrodes 90, the portions that are in contact with each other are welded simultaneously.

After the projection welding process is finished, the pair of electrodes 90 are moved to an area which is not welded yet, and the alignment process and the projection welding process are performed.

In the second embodiment, it is preferable to weld the outward ridges 46b and 66b located on the center side of the power generation areas 92a and 92b first, and then the outward ridges 46b and 66b located on the marginal side of the power generation areas 92a and 92b.

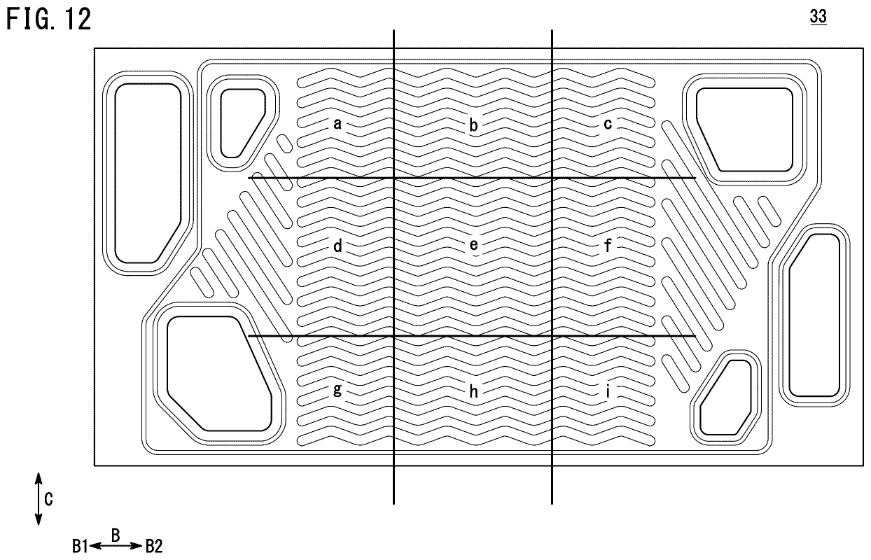

As shown in FIG. 12, when the area to be subjected to projection welding is divided into nine areas (a to i), it is preferable to weld the central area e first. For example, it is preferable to perform welding in the order of the area e, the area b, the area d, the area f, the area h, the area a, the area c, the area g, and the area i. The order of welding the area b, the area d, the area f, and the area h is not limited. Similarly, the order of welding the area a, the area c, the area g, and the area i is not limited.

Thus, it is possible to reduce the waviness of the joint separator 33 and the distortion of the joint separator 33 due to welding. According to the second embodiment, although the number of times of projection welding increases, the same effect as that of the first embodiment can be obtained.

### 4 Invention Obtained from Embodiments

Next, the invention understood from the above embodiment will be described below.

The joining method according to an aspect of the present invention is provided for joining two adjacent separators in the fuel cell stack (10) in which the unit cells (12) are stacked, each of the unit cells including the membrane electrode assembly (28) and the pair of separators (33) sandwiching the membrane electrode assembly, wherein the two adjacent separators are the first separator (30) covering the cathode (44) of the first membrane electrode assembly and the second separator (32) covering the anode (42) of the second membrane electrode assembly, the first separator includes the plurality of first inward ridges (46a) that are in contact with the cathode of the first membrane electrode assembly and the plurality of first outward ridges (46b) that protrude toward the second separator, and the second separator includes the plurality of second inward ridges (66a) that are in contact with the anode of the second membrane electrode assembly and the plurality of second outward ridges (66b) that protrude toward the first separator. The joining method includes bringing the first separator and the second separator into contact with each other, bringing the first welding electrode (90a) into contact with the plurality of first inward ridges, bringing the second welding electrode (90b) into contact with the plurality of second inward ridges; and welding the plurality of portions where the first outward ridges and the second outward ridges are in contact with each other by causing the current to flow between the first welding electrode and the second welding electrode.

According to the above method, it is not necessary to bring the first welding electrode and the second welding electrode into contact with the portions to be welded (the contact portions of the outward ridges). Therefore, the welding is easily performed. Further, according to the above method, it is not necessary to weld the portions to be welded one by one. Therefore, the welding is easily performed. Further, according to the above method, it is not necessary to accurately bring the welding electrode into contact with the portions to be welded, as in the spot welding. Therefore, the welding is easily performed. Further, according to the above method, it is not necessary to accurately grasp the portions to be welded. Thus, the welding is easily performed.

In the above method, in the state where the first welding electrode and the second welding electrode overlap the entire area of the power generation area (92a) of the first separator and the entire area of the power generation area (92b) of the second separator in plan view, the plurality of portions where the first outward ridges and the second outward ridges are in contact with each other may be welded by causing the current to flow between the first welding electrode and the second welding electrode.

According to the above method, all the portions to be welded can be welded by applying current to the pair of electrodes one time. Thus, the welding operation is simple.

In the above method, in the state where the first welding electrode and the second welding electrode overlap a part of the power generation area of the first separator and a part of the power generation area of the second separator in plan view, the plurality of portions where the first outward ridges and the second outward ridges are in contact with each other may be welded by causing the current to flow between the first welding electrode and the second welding electrode.

In the above method, the first outward ridge and the second outward ridge located on the central side of each of the power generation areas may be welded first, and then the first outward ridge and the second outward ridge located on the marginal side of each of the power generation areas may be welded.

According to the above method, it is possible to reduce the waviness of the joint separator including the first separator and the second separator, and the distortion of the joint separator due to welding.

In the above method, each of the first separator and second separator may include the fluid passage (34a, 34b, 36a, 36b, 38a, 38b) at the same position in plan view, and after the first outward ridges of the first separator and the second outward ridges of the second separator are welded, laser welding may be performed in the outer peripheral portion of the fluid passage of the first separator and the outer peripheral portion of the fluid passage of the second separator.

In the above method, after the first outward ridges of the first separator and the second outward ridges of the second separator are joined, laser welding may be performed in the marginal portion of the first separator and the marginal portion of the second separator.

Moreover, the present invention is not limited to the above-described disclosure, and various configurations can be adopted therein without departing from the essence and gist of the present invention.

1. A joining method of joining two adjacent separators in a fuel cell stack in which unit cells are stacked, each of the unit cells including a membrane electrode assembly and a pair of separators sandwiching the membrane electrode assembly,
wherein the two adjacent separators are a first separator covering a cathode of a first membrane electrode assembly and a second separator covering an anode of a second membrane electrode assembly,
the first separator includes a plurality of first inward ridges that are in contact with the cathode of the first membrane electrode assembly and a plurality of first outward ridges that protrude toward the second separator, and
the second separator includes a plurality of second inward ridges that are in contact with the anode of the second membrane electrode assembly and a plurality of second outward ridges that protrude toward the first separator,
the joining method comprising:
bringing the first separator and the second separator into contact with each other;
bringing a first welding electrode into contact with the plurality of first inward ridges;
bringing a second welding electrode into contact with the plurality of second inward ridges; and
welding a plurality of portions where the first outward ridges and the second outward ridges are in contact with each other by causing a current to flow between the first welding electrode and the second welding electrode.

2. The joining method according to claim 1, wherein in a state where the first welding electrode and the second welding electrode overlap an entire area of a power generation area of the first separator and an entire area of a power generation area of the second separator in plan view, the plurality of portions where the first outward ridges and the second outward ridges are in contact with each other are welded by causing the current to flow between the first welding electrode and the second welding electrode.

3. The joining method according to claim 1, wherein in a state where the first welding electrode and the second welding electrode overlap a part of a power generation area of the first separator and a part of a power generation area of the second separator in plan view, the plurality of portions where the first outward ridges and the second outward ridges are in contact with each other are welded by causing the current to flow between the first welding electrode and the second welding electrode.

4. The joining method according to claim 3, wherein the first outward ridge and the second outward ridge located on a central side of each of the power generation areas are welded first, and then the first outward ridge and the second outward ridge located on a marginal side of each of the power generation areas are welded.

5. The joining method according to claim 1, wherein each of the first separator and second separator includes a fluid passage at a same position in a plan view, and
after the first outward ridges of the first separator and the second outward ridges of the second separator are welded, laser welding is performed in an outer peripheral portion of the fluid passage of the first separator and an outer peripheral portion of the fluid passage of the second separator.

6. The joining method according to claim 1, wherein after the first outward ridges of the first separator and the second outward ridges of the second separator are joined, laser welding is performed in a marginal portion of the first separator and a marginal portion of the second separator.
